(19) United States
(12) Patent Application Publication
(10) Pub. No.: US 2015/0184063 A1
(43) Pub. Date: Jul. 2, 2015

(54) FORMULATION OF SURFACTANT TO ENHANCE CRUDE OIL RECOVERY

(71) Applicant: Intevep, S.A., Caracas (VE)

(72) Inventors: Xiomara Graciela Gutiérrez Santana, Caracas (VE); Luis Rafael Marcano Cova, Los Teques (VE); Raul José Saud, Los Teques (VE); Romer Alfonso Salas, Los Teques (VE); Alsis Espina, Estado Zulia (VE); María Mercedes Castillo Sánchez, Los Teques (VE)

(21) Appl. No.: 14/554,324

(22) Filed: Nov. 26, 2014

Related U.S. Application Data
(60) Provisional application No. 61/910,538, filed on Dec. 2, 2013.

(51) Int. Cl. C09K 8/584; C09K 8/588; E21B 43/16

(52) U.S. Cl. CPC C09K 8/584; E21B 43/16; C09K 8/588

(57) ABSTRACT

A method for improving recovery from an oil-bearing subterranean formation includes the steps of: injecting a surfactant solution into the subterranean formation, wherein the surfactant solution comprises a mixture of fatty acids and salts of the fatty acids with a mild base, whereby oil-water interfacial tension in the formation is reduced; and producing fluids from the formation.

### BACKGROUND OF THE INVENTION

The invention relates to a formulation of a surfactant to enhance crude oil recovery.

The need is increasing for ways to better produce, exploit and develop extra-heavy crude oil resources in the Orinoco Belt. To meet this challenge, different techniques are being evaluated to produce the extra-heavy crude oil. Despite these efforts, the amount of extra-heavy crude oil that remains in the reservoir is very high (approximately 92%). The amount of extra-heavy crude oil trapped inside the reservoir can be attributed to the following phenomena:

i) Problems of injection by preferential way, or channeling, and/or gravitational segregation.

ii) Capillary forces that cause drops of petroleum to be trapped in porous means in discontinuous form.

Methods of improved recovery are used to resist the phenomena responsible for the trapping of crude oil. These methods include injecting fluids in the reservoir, including for example fluids which are different from the fluids contained originally in the reservoir. This injection has the goal of improving displacement of the crude oil through different mechanisms, such as reduction of the mobility ratio and reduction of the crude oil-water interfacial tension.

Different methods exist to try to improve the crude oil recovery. One method is a chemical method that involves introducing chemical additives into the reservoir to change the physical/chemical properties of the displaced and displacing fluid. This is with the purpose of reducing the capillary and interfacial forces and optimizing the mobility ratio. This type of method includes the injection of polymers, surfactants and alkaline solutions.

Chemical methods have been used very little because in the reservoir the required concentrations of chemical additives are very high, and low cost of petroleum rendered such processes unprofitable. With higher costs of petroleum, chemical methods are more viable.

### SUMMARY OF THE INVENTION

Due to the problems mentioned above, the present invention has as a goal the development of useful solutions of surfactant that can be injected in the reservoir to diminish the petroleum-water interfacial tension to ultralow values, and also to reduce the viscosity of the crude oil. This is with the purpose of improving the mobility of heavy or extra-heavy crude oil in the reservoir and increasing the recovery factor. In addition, it has been found that production of heavy, medium and light crude oils can also benefit from the present invention.

The first surfactants evaluated according to the invention were fatty acid mixtures (C16-C22) and their salts generated with alkanolamine such as monoethanolamine (MEA).

Commercially, one preferred fatty acid mixture is known as “TOFA” (Tall oil fatty acid). The fatty acids present in TOFA have a structure and behavior very similar to some of the acid compounds or natural surfactant (NS) present in the heavy and extra-heavy crude oil of Venezuela. For this reason, according to the invention, TOFA is a focus of the present application and was evaluated as a surfactant.

It was found that the inorganic buses used to generate the fatty acid salts is important, as many of the typically known buses, such as NaOH or Na₂Co₃, cause problems when used downhole to improve oil recovery. Surfactants based on such inorganic buses lose their effectiveness quickly because they tend to interact with divalent metals in the formation water, such as Ca⁺² and Mg⁺² and form insoluble salts, thereby removing the components of the surfactant and rendering them ineffective. It has been found, according to the invention, that MEA and similar amines, but preferably MEA, do not have nearly the same tendency to form insoluble salts with the metals typically found in formation water, and therefore the surfactant solution of the present invention is preferably a mixture of C16-C18 fatty acids such as TOFA and salts of the C16-C18 fatty acids with MEA.

Thus, according to the invention, a method is provided for enhanced recovery from an oil-bearing subterranean formation, comprising the steps of injecting a surfactant solution into the subterranean formation, wherein the surfactant solution comprises a mixture of fatty acids and salts of the fatty acids with a mild base, whereby the oil-water interfacial tension in the formation is reduced, and producing fluids from the formation. In this way, the recovery factor from the formation can be significantly increased.

In further accordance with the invention, a method is provided for improving recovery from an oil-bearing subterranean formation, which method comprises the steps of injecting an aqueous solution of an organic base, preferably MEA into a formation containing a crude oil containing natural surfactants, whereby the injecting step contacts the aqueous solution with the crude oil to activate the natural surfactants whereby the oil-water interfacial tension in the formation is reduced, and producing fluids from the formation. Following this method, the recovery factor from the reservoir can be significantly increased.

### BRIEF DESCRIPTION OF THE DRAWINGS

A detailed description of the invention follows, with reference to the attached drawing, wherein:

FIG. 1 illustrates the relationship between capillary number and residual oil saturation in a typical crude oil bearing porous media;

FIGS. 2-7 are photographs showing emulsification of various test samples from the Example;

FIGS. 8-10 show results obtained for test samples holding fatty acid concentration constant and varying concentration of alkanolamine;

FIGS. 11-13 show results obtained for test samples holding alkanolamine concentration constant and varying concentration of Fatty acid;

FIGS. 14(a) and (b) show results of displacement tests for Formulation A;

FIGS. 15(a) and (b) show results of displacement tests for Formulation B;

FIGS. 16(a) and (b) show results of displacement tests for Formulation C;

FIGS. 17(a) and (b) show results of displacement tests for Formulation D;

FIGS. 18(a) and (b) show results of displacement tests for Formulation G;

FIGS. 19(a) and (b) show results of displacement tests for Formulation I;

FIG. 20 shows a comparison of EOR test results obtained using Formulations A-D, G and I; and

FIG. 21 shows overall recovery results so obtained.

### DETAILED DESCRIPTION

The invention relates to a surfactant solution for improving crude oil production from formations bearing such crude oils, and to a method of using such a solution.

According to the invention, oil recovery from a crude oil bearing subterranean formation can be improved by injecting into the formation a surfactant solution comprising a mixture of C16-C22 fatty acids and salts of the C16-C22 fatty acids with monoethanolamine (MEA). This injection leads to reduction in the oil-water interfacial tension in the formation and, consequently, reduces viscosity of the crude oil. The interfacial tension and viscosity are major obstacles to enhanced production from such formations. Further, because of the specific formulation of the surfactant solution, the solution maintains its effectiveness even in the presence of divalent metals commonly found in the formation water of such formations, such as Ca⁺², Mg⁺² and the like.

Some general considerations are as follows. The mechanism of surfactant action in enhanced extra-heavy crude oil recovery is critical to the invention. Generally, after the application of secondary recovery methods such as sweeping with water (water flooding), crude oil is trapped inside the pores by viscous and capillary forces. The magnitude of these forces can be accounted for by the capillary number, Nc, which is defined as follows:

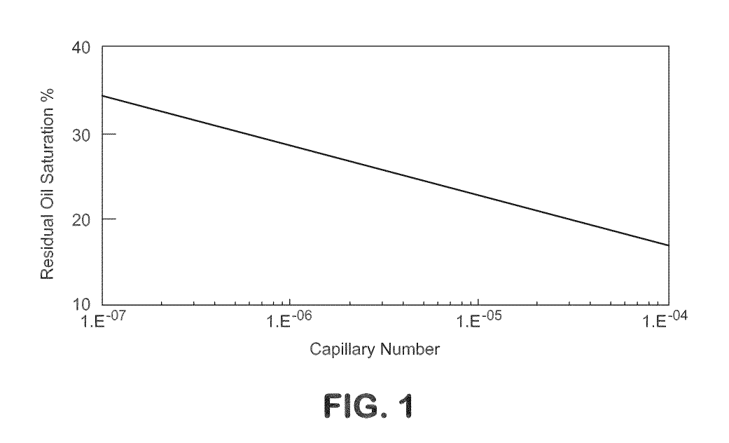

Nc=(μ_{w}ν_{w}/γ_{ow})

Where: μ_{w} (Pa·s) is the viscosity of the water (displacement fluid), ν_{w} (Darcy (m/s)) is the water velocity and γ_{ow} (N/m) is the oil-water interfacial tension. When crude oil is trapped inside the porous media, the capillary number can be around 10⁻⁷ to 10⁻⁶, which means that the forces trapping the crude oil are enormous. As indicated in FIG. 1, to overcome these forces and recover a significantly greater amount of crude oil or to diminish the residual crude oil saturation, it is necessary to increase the capillary number by three orders of magnitude (to 10⁻³ or 10⁻⁴). In the case of extra heavy and heavy crude oil, the residual crude oil saturation can be up to 90% or more.

In order to increase the capillary number to the range of 10⁻⁴ to 10⁻³, according to the equation, the viscosity or velocity of the fluid can be increased, or the interfacial tension can be decreased from 30 (the approximate interfacial tension of crude oil-water) to 10⁻³-10⁻⁴ mN/m. Any attempt to increase fluid velocity involves the use of high pressures which can collapse the rock structure, thus creating preferred paths of high porosity, and possibly leading to channeling. Increasing the viscosity is also impractical (similar to blowing honey through a straw). Therefore, in order to increase the capillary number, it is necessary to diminish the interfacial tension (IFT) of entrapped oil. The interfacial tension of oil-water systems is diminished by injection into the reservoir of effective surfactant formulations. The injection of surfactant formulations into the reservoir according to the invention can also change the wettability of the porous media and diminish the viscosity of heavy or extra heavy crude oil. All this brings, as a consequence, the improvement of mobility of crude oil in the reservoir and an increase of crude oil recovery.

Low IFT can be obtained with a wide variety of surfactants, but the best surfactant depends on the crude oil and reservoir conditions and must also satisfy several other stringent requirements. These requirements include low retention, compatibility with the electrolytes and polymer, thermal stability, aqueous stability, no formation of stable emulsions with the crude oil (since this can cover pores), and low cost. Surfactant retention is due in part to adsorption on the rock surfaces. Generally it is difficult for a surfactant formulation to have all these conditions.

Surfactant mixtures can be used to obtain ultralow interfacial tension in crude oil-water systems. This is because with surfactant mixtures, the most favorable interactions of surfactant molecules at the level of the interface are obtained. Consequently, the greater adsorption of surfactant in the interface, the greater reduction in interfacial tension is obtained. Effective surfactant mixtures can be formed with carboxylic acids of long chain (≧C12) since when these acids are ionized with a basic compound (pH ≧11), a mixture is obtained of un-ionized acid and acid salt (carboxylate). The un-ionized acid can act as a nonionic surfactant and its salt as an anionic surfactant and to produce a surfactant mixture that can produce ultralow interfacial tensions when they are adsorbed at oil-water interface. The best formulation is obtained when the relation between carboxylic acid and its salt is near 1.

One main problem that occurs with the fatty acid/fatty acid salt mixtures when they are injected in the reservoir is that the interaction of the basic compound with divalent metals such as calcium and magnesium (Ca⁺² and Mg⁺²) dissolved in the reservoir water forms insoluble salts that precipitate in the reservoir. When these salts precipitate, the equilibrium acid-base between the surfactant mixture and the basic compound is broken, and consequently the surfactant loses its effectiveness. Additionally, the salts of acid (anionic surfactant) also can interact with divalent metals of Ca⁺² and Mg⁺² to form insoluble salts of magnesium or calcium carboxylate, thereby losing surfactant properties.

On the other hand, the basic compounds frequently used to activate surfactant of fatty acids such as TOFA are inorganic bases such as NaOH, Na₂CO₃ and Na₂SiO₃. When these inorganic bases react with TOFA, a surfactant mixture of acid and its salt of sodium carboxylate is produced. These sodium carboxylates can react with divalent cations dissolved in the reservoir water to form insoluble salts that precipitate in reservoir and the surfactant loses its properties.

Additionally, these inorganic bases (NaOH, etc.) can be very reactive with components of the formation and consequently they can quickly lose their capacity to maintain pH at a value ≧10. This is necessary, however, so that the acid-base equilibrium between fatty acids and their salts remain in the crude oil-water interface and the interfacial tension remains low.

It has been found according to the invention that mild bases, preferably weak organic bases such as monoethanolamine (MEA) are sufficiently weak organic bases that the salts of MEA carboxylate are less reactive with calcium and magnesium divalent cations. Thus, according to the invention, their reactivity with porous media and the formation of divalent salts is lower when compared with conventional alkalis such as NaOH, Na₂CO₃ and Na₂SiO₃.

The discovery in accordance with the invention that weak organic bases such as MEA could produce the desired surfactant and, thereby, the desired oil-in-water emulsion, downhole, without the rapid deactivation expected when other types of solutions are used, is a surprising development which leads to the potential for advantageous implementation of the method according to the invention. Specifically, because the weak organic base does not lead to rapid reaction with the divalent cations expected to be encountered, the high pH and surfactant solution have sufficient stability to allow production of the heavy crude oil in an emulsion, and thereby greatly increase the recovery factor of such crude oil.

The advantageous results of the present invention can be implemented in either or both of two different ways.

First, it is known that heavy crude oils typically contain natural surfactants which can be activated through contact with suitable basic materials, particularly through contact with the weak organic base in accordance with the present invention. Thus, if the heavy crude oil which is to be produced contains such natural surfactants, the method of the present invention can be carried out by pumping into the formation a solution which contains the weak organic base. This can be, for example, in the form of an aqueous solution containing MEA.

Second the solution can include the fatty acids discussed above, such as TOFA, particularly if the heavy crude oil to be produced contains insufficient or no natural surfactants.

In either approach, it is preferred for the surfactant solution to be formulated sufficiently to provide a pH, when contacted with the fatty acid, which remains greater than or equal to about 10, even in the presence of divalent metal(s).

In further accordance with the present invention, it has been found that results obtained through injection of the surfactant solution can be further enhanced through including a polymer in the surfactant solution. This is particularly preferred when the solution is being used to activate natural surfactants in the crude oil. A suitable example of polymer which can be advantageously used according to the invention includes hydrolysed polyacrylamide (HPAM).

When a polymer is to be used in accordance with the present invention, excellent results are obtained with a small concentration, for example between 0.05 and 0.5 wt. %.

According to the invention, it has been found that the amount of MEA used with an extra-heavy crude oil-water system as disclosed herein reduced the oil-water interfacial tension significantly, with results as follows:

| | Interfacial |
|---|---|
| | Tensión. |
| % MEA | (γ) (mN · m) |
| 0.3 | 7.00E−03 |
| 0.5 | 2.00E−03 |
| 0.7 | 8.00E−04 |
| 1 | 6.00E−04 |
| 1.2 | 5.00E−04 |

Further, according to the invention, the use of polymer in the solution and system according to the invention also helps to greatly reduce the interfacial tension as shown below:

| % Polymer | (γ) (mN · m) |
|---|---|
| 0 | 8.00E−04 |
| 0.05 | 2.20E−01 |
| 0.1 | 7.30E−02 |
| 0.2 | 1.90E−02 |
| 0.4 | 5.00E−03 |

Use of polymer in the present invention also helps to increase the overall cumulative production of the oil in place. For example, use of polymer at a rate of 0.2% vol. along with 0.7% MEA provided a general increase in production of IOIP of about 15% as compared to the process disclosed herein without polymer (only 0.7% MEA), and both MEA flooding and MEA+polymer flooding provide significant increases in cumulative production of the oil in place as compared to water flooding.

The method of the present invention can advantageously be employed to enhance the recovery factor in numerous crude and heavy crude oil-bearing formations, but particularly in formations where the crude oil has an API gravity of less than 10, typically about 8. In accordance with the invention, the solution forms an oil-in-water emulsion with this heavy crude oil, and the emulsion has a drastically reduced viscosity, typically less than about 400 mPas.

In further accordance with the invention, it has been found that desirable results are obtained when the solution contains the fatty acid component in a concentration between 0.7 and 2.0 vol. %. Further, the mild base can preferably be provided in a concentration in the solution of between 0.3 and 1.5 vol. %.

In further accordance with the invention, it can be advantageous to include an electrolyte in the surfactant solution. One particularly preferred electrolyte is sodium chloride (NaCl). Ideally, the solution can be provided with NaCl in an amount of about 0.5 wt %.

As indicated above, the method of the present invention forms a sufficiently stable emulsion, downhole, with the heavy crude oil that production of the heavy crude oil can be significantly increased. The emulsions so formed have an average droplet size of between 1 and 20 μm.

It should be appreciated that the method disclosed above embodies a particularly useful discovery according to the invention, namely, that certain forms of surfactant solution can be used to create a stable and basic surfactant solution, downhole, which then forms an emulsion of the heavy crude oil in the formation with the surfactant solution and other water, so as to greatly enhance the producibility of this heavy crude oil.

An aqueous formulation of surfactant using TOFA and TOFA salts generated with MEA was developed to inject into a porous media. The formulation was used in a porous media that has a reducible saturation of an extra-heavy crude oil (8° API) and an irreducible saturation of formation or reservoir water (high content of salts). The recovery factor for enhanced extra-heavy crude oil recovery was determined. Additionally, the recovery factor obtained with the formulation was compared with the recovery factor obtained when pure water is injected (low content of salts). The recovery factor obtained when pure water was injected in the porous media was 12.67. The recovery factor obtained when the surfactant formulation is injected, wherein the surfactant formulation was 1% TOFA, 0.7% MEA and 0.5% NaCl, is 22.58%, which is an increase of 79% in the recovery factor when compared with pure water.

It should be appreciated that the surfactant formulation according to the invention can increase the recovery factor of an extra-heavy crude oil by 79%. The surfactant formulation is a mixture of TOFA and TOFA salts generated with MEA, which is injected in porous means that is at a water irreducible saturation and a reducible saturation of an extra-heavy crude oil of 8° API. The injection in the porous means of an aqueous optimal formulation of the surfactant mixture of TOFA and its salts of MEA compatible with the formation water, as a method to increase the recovery factor of an extra-heavy crude oil to 79%, meets the objectives of the invention to provide an effective chemical approach to increasing production of extra heavy crude oils.

This optimal formulation consists of a specific relation between the concentrations of TOFA and MEA which react to generate the mixture of TOFA and their salts of MEA.

The following example further demonstrates the effectiveness of the method according to the present invention.

### Example

### Additives to Prepare the Oil/Water/Chemical Systems

The surfactant formulation employed was a mixture of fatty acids partially neutralized by basic compounds, namely, water soluble alkanolamines and an electrolyte (sodium chloride, NaCl). These components were mixed or diluted in de-ionized water, varying the concentration of fatty acids mixture/base to obtain different formulations to be evaluated. The velocity of mixing varied between 300 and 400 rpm for durations of 20 to 40 minutes, depending on the formulation. A mechanical stirrer is used. Fatty acids are blends of C16-C22 molecules. The ionization of the fatty acids is achieved by adding to the water a basic agent, namely mono ethanolamine (MEA), which promotes the formation of the corresponding carboxylates (the ionized form of the fatty acids). By controlling the relationship between the fractions of fatty acid and its carboxylate ion, it is possible to adjust the characteristics of the surfactant formulation.

The oil sample used was collected from the Cerro Negro field located in the Orinoco Belt, and then it was submitted to a physicochemical analysis. This oil is classified as extra-heavy oil (8.1° API) and its viscosity is about 10900 mPas at 60° C.

### Phase Behavior Screening

This experimental stage is divided in two parts: a) emulsification tests to be analyzed qualitatively; and b) emulsion characterization, where properties were measured, namely droplet size, interfacial tension (IFT), and viscosity.

### Emulsification Tests

This test was conducted to demonstrate the chemical formulations that are best suited for a promising EOR process. To proceed with the screening process, the first criterion taken into consideration when making the first set of chemical formulations was to keep fixed the fatty acids concentration value at 1.0 vol % as a preliminary start point, and to vary the alkanolamine (MEA) concentration. A concentration of NaCl held constant at 0.5 wt % was added to all the formulations. The NaCl was used because it has been demonstrated in previous studies that the presence of this salt helps to reduce considerably the IFT to ultra-low values, and in addition, promotes the solubilization of the oil and aqueous phases. Table 1 shows the formulations prepared:

TABLE 1
Chemical formulations Set A

| | Fatty acids | | |
|---|---|---|---|
| | mixture | Alkanolamine | NaCl |
| | Concentration | Concentration | Concentration |
| Formulation | (vol %) | (vol %) | (wt %) |
| A | 1.0 | 0.3 | 0.5 |
| B | 1.0 | 0.5 | 0.5 |
| C | 1.0 | 0.7 | 0.5 |
| D | 1.0 | 1.0 | 0.5 |
| E | 1.0 | 1.3 | 0.5 |
| F | 1.0 | 1.5 | 0.5 |

50-ml bottles were prepared and filled with oil and the respective chemical formulation with a volume ratio of 50:50, i.e. 25 ml oil and 25 ml of formulation. These bottles were hermetically capped and then introduced in an oven at 60° C., very gently, avoiding any mechanical disturbance. After two hours, the bottles were reviewed in order to corroborate if a spontaneous emulsification between the oil and the surfactant formulations had taken place.

The bottles were then agitated manually for periods of two hours each until a total time of six hours was reached. In every turn, they were placed also back to the oven at 60° C.

A second set of chemical formulations (Set B) was prepared, taking into consideration the results obtained from the phase behavior analysis of Set A. In this case, the alkanolamine concentration was fixed at 0.7 vol % to screen the fatty acids mixture concentration. The bottles preparation procedure was the same as with Set A. Table 2 presents the composition of Set B formulations:

TABLE 2
Chemical formulations Set B

| | Fatty acids | | |
|---|---|---|---|
| | mixture | Alkanolamine | NaCl |
| | Concentration | Concentration | Concentration |
| Formulation | (vol %) | (vol %) | (wt %) |
| G | 0.7 | 0.7 | 0.5 |
| H | 1.1 | 0.7 | 0.5 |
| I | 1.3 | 0.7 | 0.5 |
| J | 1.5 | 0.7 | 0.5 |
| K | 2.0 | 0.7 | 0.5 |

b) Emulsion Characterization

The emulsions obtained were subjected to the measurement of average droplet diameters to ascertain the distribution frequency of their droplet size, which represents the volumetric ratio of the droplets with respect to the total volume of the internal phase. This parameter is very significant in practice due to the fact that both the viscosity and the stability of the emulsion depends on it. A particle size meter device was used.

The next step was to ascertain the oil-water interfacial tensions (IFT) for each of the surfactant formulations. This was possible by using a spinning drop tensiometer. In this method, both the aqueous and oil phases are contained within a capillary tube which rotates at high speed allowing the oil drop length to become larger than four times its diameter, and thus, accomplishing the L/D≧4 condition required by the built-in software system. The equation used to calculate the IFT values is:

σ=3.42694×10⁻⁷·(ρₕ−ρ_{d})·ω²·D³

### Where:

σ is the IFT (dyne/cm); ρₕ is the density of the aqueous phase (g/cm³); ρ_{d} is the oil phase density; ω is the rotational velocity (rpm); and D is the drop diameter (mm).

Finally, the viscosity of all the emulsions and surfactant formulations were ascertained by using the Rotovisco RV30 viscometer.

Displacement Tests—Chemical Flood Study

Displacement tests were conducted to validate the effects of the potential surfactant formulations previously identified during the phase behavior stage. To perform these experiments, a coreholder (or cell) of 30.48 cm length and 3.5 in diameter was used. This coreholder was filled with fresh sand (U.S. Silica) of 70-100 mesh. In order to guarantee the same wettability for all the tests, the coreholder was packed each test, by adding the sand in several increments while vibrating it for 15 minutes each time, up to filling the cell completely. The absolute permeability of the porous medium was estimated by passing a flow of nitrogen through the sandpack, yielding a value of 11.34 D. After this, the packed coreholder was subjected to a vacuum process to then be 100% saturated by injecting formation brine at a rate of 1.0 cm³/min for 5 hours. The pore volume (PV) was determined by a mass balance given by the volume occupied by the brine once the porous medium had been pressured to 68 atm (1000 psi). The porosity was ascertained as 38%, while the permeability to water was 4.6 D. The coreholder was placed horizontally to perform all the tests at a temperature of 60° C.

The next step was to saturate the sandpack with the extra heavy oil at a rate of 0.5 cm³/min. The oil injection process ended when there was no more production of brine, i.e. when the water cut was less than 1%. At this point, the irreducible water saturation (S_{wir}) was ascertained. The process to measure the effective permeability to oil was also performed.

Then, the sandpack was waterflooded with deionised water at a rate of 1.0 cm³/min. After this, the tertiary chemical flood tests took place, with the rate of injection at 0.5 cm³/min. Both water and surfactant formulations were injected from 0.2 to 1.0 pore volume (PV) with increments of 0.2 PV each. The produced fluids were separated (oil and water) and quantified after each increment, in both waterflooding and chemical injection process.

### Emulsification Tests

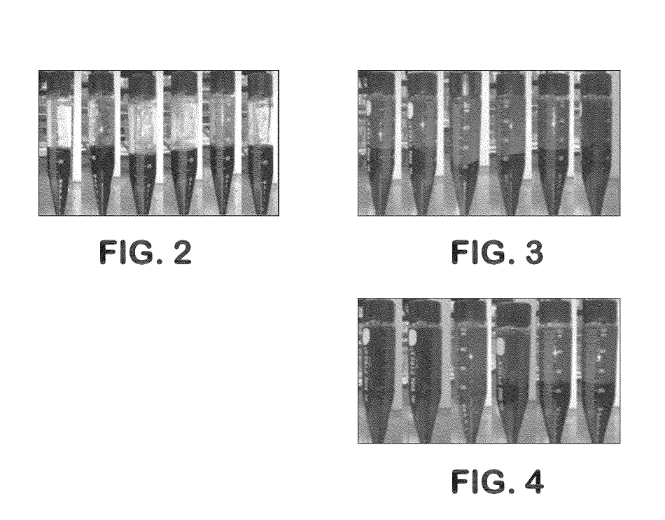

After two hours, the bottles were reviewed in order to corroborate if a spontaneous emulsion between the oil and the surfactant formulations had taken place. FIG. 2 shows the bottles at that time with formulations A-F being shown left to right. After this, the bottles were agitated manually for periods of two hours each until a total time of six hours was reached. In every turn, they were placed also back to the oven at 60° C. Between these periods of two hours each, pictures were taken (FIG. 3, 4 hours, and FIG. 4, 6 hours) and the spontaneous emulsification system can be seen in all cases. The emulsions formed are heavy crude oil in water.

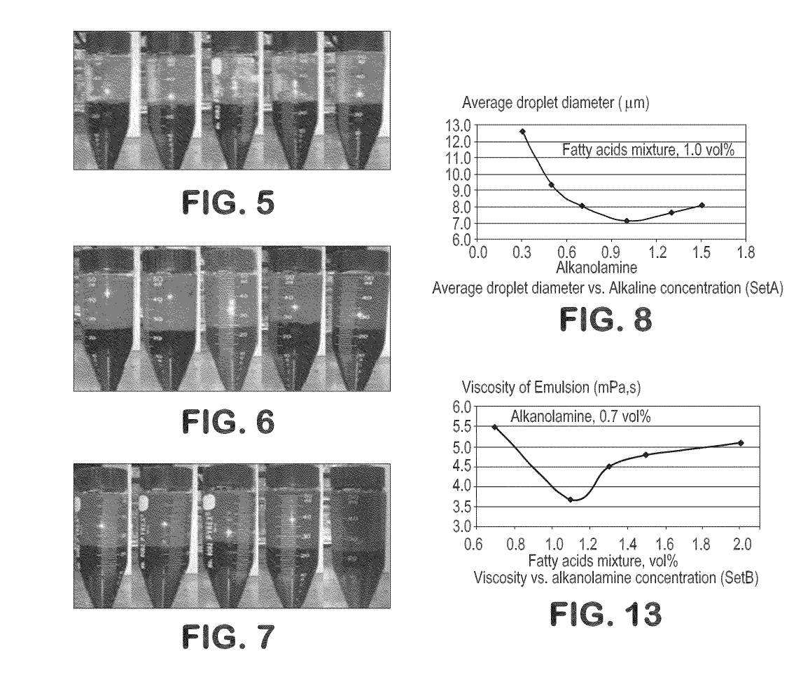

As performed with Set A formulations, FIGS. 5, 6, and 7 show the status of formulations G, H, I, J and K in the bottles at two, four, and six hours, respectively. Spontaneous emulsification systems were observed at four and six hours of contact between the phases.

Studies of phase behavior show that surfactant formulations are well-suited for application as a chemical method of analyzed extra-heavy oil enhanced recovery.

Emulsion Characterization

Set A

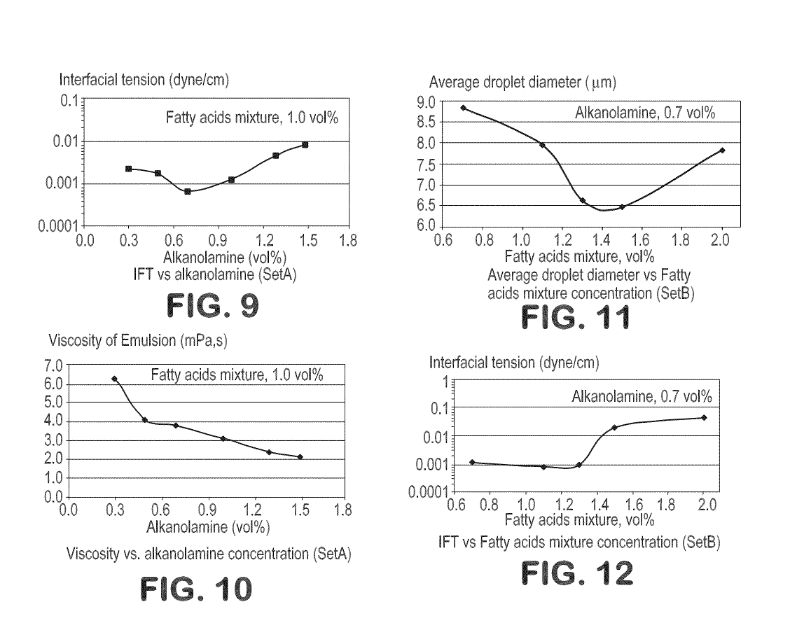

Measurements of average droplet size in the extra heavy crude oil in water emulsions (FIG. 8) and interfacial tension (IFT) (FIG. 9) were made in order to study the synergy between oil and surfactant formulations. In addition, the viscosities were also measured (FIG. 10). FIGS. 8, 9 and 10 show the different curves for such properties determined.

As can be observed, in the extra heavy crude oil in water emulsions the average droplet diameter diminished and reached a minimum value (˜7.0 μm, FIG. 8) when alkanolamine concentration increased up to 1.0 vol %. From that point on, droplets became larger again. These results demonstrate that the surfactant formulation has excellent properties to emulsify the extra heavy crude oil analyzed.

The IFT measured (FIG. 9) shows that ultra-low values were achieved when the alkanolamine concentration was between 0.7-1.0 vol %; with IFT increasing at higher values from this range. The ultra-low IFT value is the result of the formation of the carboxylate as the alkanolamine concentration is increased. These carboxylates behave as a highly hydrophilic surfactant and therefore have tendency to be adsorbed on the oil-water interface to reduce the interfacial tension. When the concentration is very high, alkanolamine may adsorb many carboxylates in the oil-water interface and cause an effect of electrostatic repulsion between the negative charges of these carboxylates, which results in desorption of the carboxylates of the interface and increased interfacial tension. When the alkanolamine concentration is very high, it may adsorb many carboxylates in the oil-water interface and cause an effect of electrostatic repulsion between the negative charges of these carboxylates, which results in desorption of these carboxylates of the interface and increased IFT. The alkanolamine concentration of 0.7 vol % was fixed in order to screen the surfactant concentration in a new set of formulations (Set B), because at this concentration the IFT showed the lowest value (˜0.0007 dyne/cm).

Set B

FIG. 10 shows that the viscosity of the emulsion decreases as the concentration of alkanolamine is increased. These values were very close to the viscosity of the water phase.

As in Set A, the emulsions formed with formulations of Set B were characterized to evaluate the surfactant concentration effect on their properties in the presence of 0.7 vol % of alkanolamine. FIGS. 11, 12 and 13 show the results obtained.

FIGS. 11, 12 and 13 show that when the concentration of alkanolamine is constant at 0.7% and the fatty acid mixture concentration is varied, a similar trend to that observed in FIGS. 8, 9 and 10 is obtained, at least to a fatty acids mixture concentration of 1.3%. When the concentration of the fatty acid mixture is less than or equal to 1.3%, the average drop diameter, the interfacial tension and the viscosity all decrease. When the concentration of the mixture of fatty acids is higher than 1.3%, the average drop diameter, the interfacial tension and the viscosity begins to increase (see FIGS. 11, 12 and 13).

Of the phase behavior studies, several surfactant formulations were selected for testing of physical simulation or core flow and determining the recovery factor of extra heavy crude oil under study. These surfactant formulations were considered excellent formulations because they exhibit ultralow IFT and low values of the average droplet diameter. Table 3 summarizes the formulations selected to be evaluated in the physical simulation tests:

TABLE 3
Chemical formulations selected for
displacements tests

| | Fatty acids | | |
|---|---|---|---|
| | mixture | Alkanolamine | NaCl |
| | Concentration | Concentration | Concentration |
| Formulation | (vol %) | (vol %) | (wt %) |
| A | 1.0 | 0.3 | 0.5 |
| B | 1.0 | 0.5 | 0.5 |
| C | 1.0 | 0.7 | 0.5 |
| D | 1.0 | 1.0 | 0.5 |
| G | 0.7 | 0.7 | 0.5 |
| I | 1.3 | 0.7 | 0.5 |

Displacement Tests—Results

Six tests were conducted to evaluate the effect of the formulations selected on total oil recovery, as an EOR method based on in situ emulsification of the heavy oil into the aqueous phase.

As alternative observation, variables were taken into account for the average pressure drop (recorded during the tests), as well as water cut (obtain by distillation).

The results obtained during each test are set forth below in a set of graphs reproduced in the drawings. These show both the waterflooding stage and the chemical injection stage.

Formulation A:

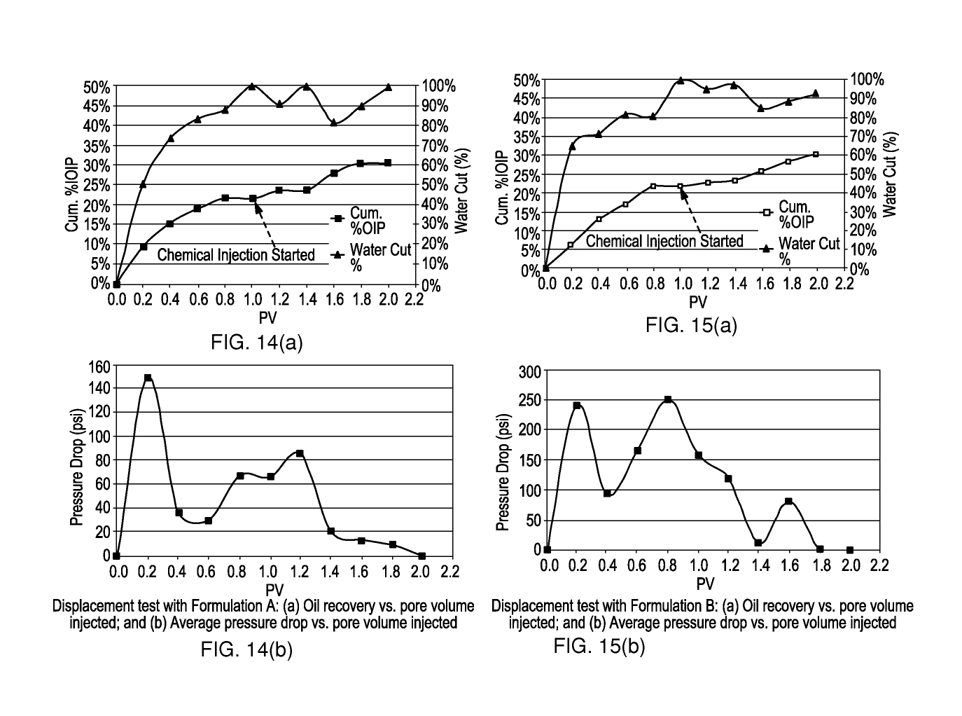

The oil recovery obtained from the waterflooding was 21.6%, with almost 100% water cut. When the chemical injection finished, the ultimate recovery obtained was about 30.5%, with a final water cut of 99.43%. It can also be observed that when chemical flooding started, both the oil recovery and the pressure rose, which was an indicator that there was a reaction between the chemical formulation and the residual oil (see FIG. 14(a), showing cumulative production percentage of the initial oil in place (IOIP) and FIG. 14(b), showing pressure drop.

Formulation B:

FIG. 15 shows that the waterflooding process brought an oil recovery similar to Formulation A (21.6%), and 99.5% water cut. Similarly, 30.07% ultimate recovery and 92.18% water cut were obtained once chemical injection ended. The pressure response showed a sharp increase, as did oil production.

Formulation C:

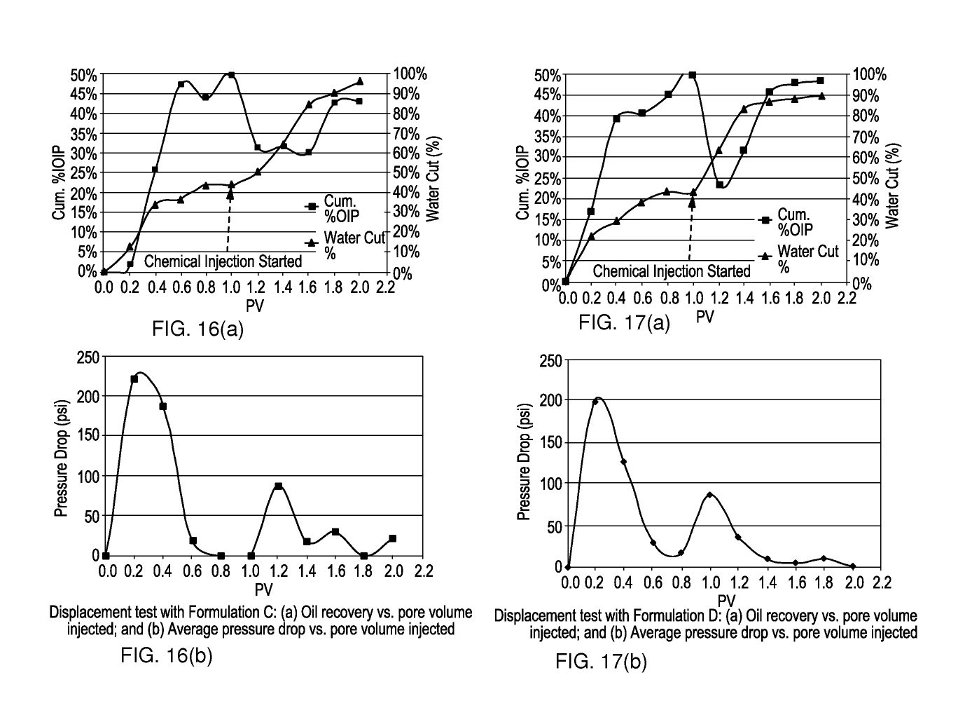

The results obtained in this test were very different from those previously observed. The oil recovered by the waterflooding process was almost the same (around 22%), but oil production showed a steep increase after chemical injection started, reaching 48.15% as ultimate oil recovery, with 86% water cut. The behavior of pressure drop curve also indicates that there was a quite effective interaction between the residual oil and chemical solution (see FIGS. 16(a) and (b)).

Formulation D:

In this test, chemical flooding had a behavior quite similar to that of Formulation C, but the ultimate oil recovered was a little bit less (˜45%); and the water cut reached a significantly higher value (97%), despite the fact that there was more alkanolamine than the Formulation C. However, the pressure response also had the same behavior described in the previous tests (see FIGS. 17(a) and (b)).

Formulation G:

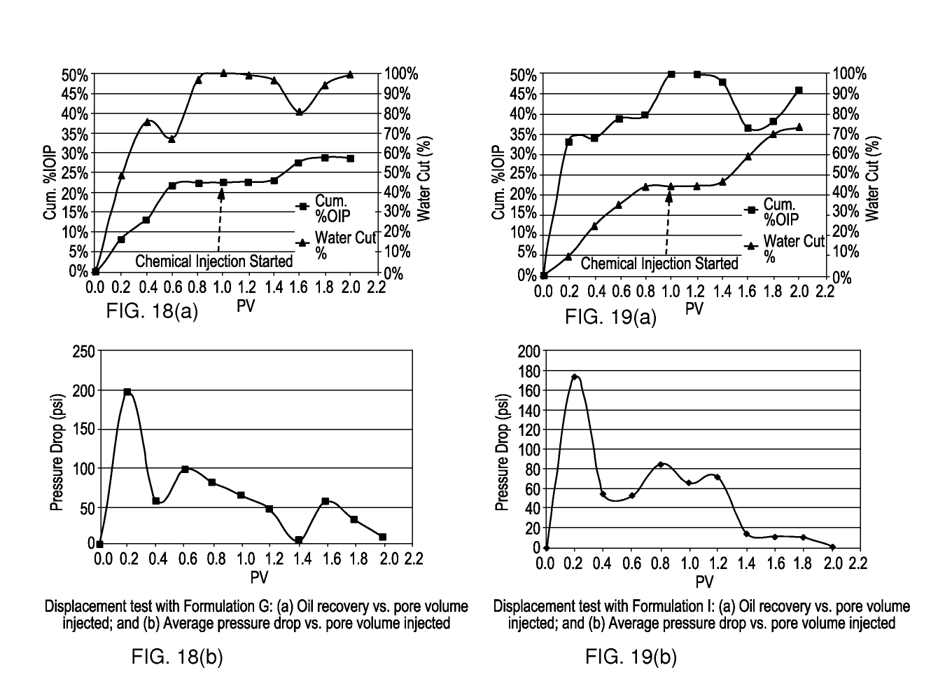

The results obtained with Formulation G were quite similar to those from tests with Formulations A and B. FIGS. 18(a) and (b) show that the cumulative oil recovered after the chemical flooding did not exceed 30%; among a high water cut (˜100%). Pressure drop curve was a little bit more “smooth” as compared to the previous tests performed.

Formulation I:

An ultimate cumulative oil recovery of ˜37% was obtained, with water cut a little bit less than 95%. Pressure drop followed the same behavior as in previous tests. It can be observed that oil recovery remained constant (˜22%) until 0.6 PV of chemical solution started injecting, showing a sharp increase at that point (see FIGS. 19(a) and (b)).

All the curves presented show that the recovery effect did not commence immediately with the injection of the formulations. This phenomenon is related to the necessity of overtaking the resistance forces offered by the fluids originally in place, and therefore an increase of pressure takes place. On the other hand, the water cut behavior in each test proved that, before the oil recovery percentage was boosted, an oil bank was formed. Also, all the pressure drop responses are indicators of the imminent reaction between the oil and chemicals.

Phase behavior tests showed that all the chemical formulations prepared with the mixture of fatty acids and their salts, activated by the presence of an alkanolamine, can form spontaneous oil-in-water emulsions with the extra heavy crude oil. Six chemical formulations were selected to perform the core flow tests, according to the fact that they showed ultra-low IFT, medium droplet diameter, and very low viscosities (see Table 4). These conditions are associated with the reduction of the capillary forces, which translates in some ways to increase the oil mobilization, such as: reduction in the cohesion/adhesion forces that are wettability critical conditions; and reduction in emulsification job.

TABLE 4
Emulsion characterization summary with
selected Chemical formulations

| | Average | | |
|---|---|---|---|
| | droplet | | Viscosity |
| Formulation | diameter (μm) | IFT (dyne/cm) | (mPa · s) |
| A | 12.61 | 0.0023 | 6.3 |
| B | 9.34 | 0.0018 | 4.1 |
| C | 8.06 | 0.0007 | 3.8 |
| D | 7.15 | 0.0013 | 3.1 |
| G | 8.84 | 0.00117 | 5.5 |
| I | 6.63 | 0.00096 | 4.5 |

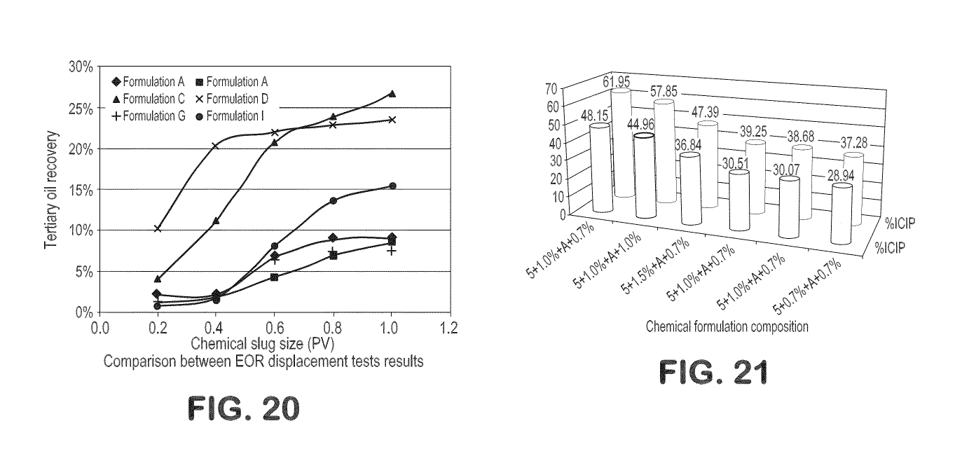

A comparison of the effect on oil recovery caused by the injection of the selected formulations to the porous medium is shown in FIG. 20. The main aspect to be highlighted is that the highest tertiary oil recovery of 26.5% (48.15 cum % after waterflooding) was obtained by Formulation C. Moreover, the water cut obtained by injecting 1.0 PV of formulation was 86.32%, which indicates that one may continue to inject more volume of the formulation for greater oil recovery until the water cut becomes higher than 95%. It is important to observe that Formulation D (which has a little more alkanolamine) quickly recovered oil with lower injection volumes; however, there comes a point where the variation of oil recovery is almost constant due perhaps to rapid degradation (adsorption) of the A/S system in the porous medium, reaching just 23.4%.

Formulations G and I depict a similar behavior in the early stages of the injection, but then the one with the highest surfactant concentration increased to obtain 15.2% (36.84 cum % after waterflooding) oil but still stayed much below Formulation C. This fact could be due to the lack of sufficient alkanolamine to ionize the fatty acids that allows for more efficient reaction with the residual oil inside the coreholder. The overall results of oil recovery (waterflooding+tertiary recovery), expressed as cumulative % IOIP (initial oil in place) and cumulative % ROIP (residual oil in place) are presented in FIG. 21.

All the displacement tests indicated that there was an effective interaction between the injected chemical formulations and the residual oil. Therefore, the latter was displaced out of the coreholder because it was dispersed into the aqueous phase. Thus, this fact is consistent with the results of the phase behavior studies which showed that there was a mass transfer near the oil/water interface (spontaneous emulsions); while the IFT measured indicated a low transient dynamic gradient.

The statements abovementioned explain that the physicochemical processes that took place during the chemical flood tests might cause the residual heavy oil to break up into smaller droplets so it could be easily entrained in the produced aqueous phase. Therefore, the ultra-low IFT allows the oil droplets to enlarge in the flow direction which tends to split them and connect with each other, and with the entrapped droplets; reducing the flow resistance (improved mobility) and increasing the sweep efficiency due to the formation of “threads” that contribute to the biphase flow regime of the oil bank.

Another explanation for the EOR effect evaluated is the possible change of the wettability in the porous medium. It is known that the sand employed to fill the coreholder is charged negatively (Potential Z=−56.8 mV), and the chemical formulations are in part comprised by both non-ionic and anionic surfactants (fatty acids and their salts, respectively) which adsorb in the oil/water interface giving a negative charge to oil. As consequence of this, an electrostatic repulsion between the porous medium and the emulsions formed in situ might take place which would facilitate the oil displacement and contribute to enhance the oil recovery factor.

Phase behavior studies were conducted to screen surfactant and alkali concentrations through qualitative and quantitative analysis for the characterization of the extra heavy crude oil/chemical formulation systems prepared. The main conclusions from these studies are: (1) The emulsions obtained were all oil-in-water type, and they did not need excessive manual agitation energy to form (spontaneous emulsification); (2) Extra heavy crude oil/aqueous phase interfacial tension can be highly reduced to ultra-low values (˜0.001 dyne/cm) by adding the surfactant mixture of fatty acids and an alkanolamine; and (3) Oil-in-water emulsions obtained showed average drop diameters from 6.5 to 12.5 μm; and very low viscosities from 2.0 to 6.5 mPas.

To conduct the core flow tests, six chemical formulations were selected, which showed the best properties when forming emulsions and the following results were obtained: (1) A maximum cumulative oil recovery of 48.15% IOIP (26.5% tertiary oil recovery), among 86.32% water cut were reached after waterflooding, using 1.0 fatty acids mixture+0.7 Alkanolamine vol %+0.5 NaCl wt % formulation; and (2) By injecting the alkanolamine/fatty acid mixture chemical formulations into the porous medium, water cut and pressure drop responses showed marked trends. The former was highly reduced, and the latter was significantly increased to indicate that an oil bank has been formed.

Finally, as an overall conclusion it is possible to affirm that: (1) Fatty acids showed excellent surfactant characteristics when activated with an alkanolamine to form carboxylate salts; (2) The ultra-low values of interfacial tension lead to enhanced oil mobility and a reduction in the cohesion/adhesion processes which are critical in the change of wettability of the porous medium, and the generation of appropriate conditions for emulsification phenomenon; and (3) The EOR method developed in this project represents a potential alternative to improve the exploitation of Venezuelan and other extra heavy crude oil reservoirs, because it is highly-effective, economically attractive (low cost), and operationally reliable.

It should be appreciated that the present invention is useful for enhanced production of crude oil generally, for example having API gravity between 11 and 31.1 or more, but that a particularly preferred use is with heavy and extra heavy crude oil having API gravity of less than 10.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

1. A method for improving recovery from an oil-bearing subterranean formation, comprising the steps of:
injecting a surfactant solution into the subterranean formation, wherein the surfactant solution comprises a mixture of fatty acids and salts of the fatty acids with a mild base, whereby oil-water interfacial tension in the formation and viscosity of crude oil in the formation are reduced; and
producing fluids from the formation.

2. The method of claim 1, wherein the formation contains divalent metals, and wherein the mild base is a weak organic base whereby the surfactant solution maintains a pH of ≧10 even in the presence of divalent metals.

3. The method of claim 2, wherein the divalent metals are selected from the group consisting of Ca⁺², Mg⁺² and combinations thereof.

4. The method of claim 2, wherein the fatty acid is a C16-C22 fatty acid.

5. The method of claim 2, wherein the weak organic base is monoethanolamine (MEA).

6. The method of claim 1, wherein the formation contains an extra-heavy crude oil having an API gravity of less than 10, and wherein the solution forms an oil-in-water emulsion with the extra-heavy crude oil, the emulsion having a viscosity of less than about 400 mPas.

7. The method of claim 1, wherein the solution contains fatty acid in a concentration between 0.7 and 2.0 vol. %.

8. The method of claim 1, wherein the solution contains mild base in a concentration between 0.3 and 1.5 vol %.

9. The method of claim 1, wherein the solution further comprises an electrolyte.

10. The method of claim 9, wherein the electrolyte is NaCl.

11. The method of claim 10, wherein the solution contains NaCl in an amount of about 0.5 wt. %.

12. The method of claim 6, wherein the emulsion has an average droplet size of between 1 and 20 μm.

13. A method for enhanced recovery from an oil-bearing subterranean formation, comprising the steps of:
injecting a solution of a mild base into a formation containing a heavy crude oil containing natural surfactants and at least one divalent metal selected from the group consisting of Ca⁺², Mg⁺² and combinations thereof, whereby the injecting step contacts the solution with the natural surfactants to form a basic surfactant solution having a pH of at least 10, and thereby to form an oil in water emulsion of the heavy crude oil; and
producing the oil-in-water emulsion.

14. The method of claim 13, wherein the solution with mild base further comprises a polymer.

15. The method of claim 14, wherein the solution contains the polymer in an amount between 0.05 and 0.5 wt. %

16. The method of claim 13, wherein the formation contains an extra-heavy crude oil having an API gravity of less than 10, and wherein the solution forms an oil-in-water emulsion with the extra-heavy crude oil, the emulsion having a viscosity of less than about 400 mPas.

17. The method of claim 13, wherein the solution contains mild base in a concentration between 0.3 and 1.5 vol %.

18. The method of claim 13, wherein the solution further comprises an electrolyte.

19. The method of claim 18, wherein the electrolyte is NaCl.

20. The method of claim 19, wherein the solution contains NaCl in an amount of about 0.3 wt. %.

21. The method of claim 13, wherein the emulsion has an average droplet size of between 1 and 20 μm.
